(19) United States
(12) Patent Application Publication
(10) Pub. No.: US 2016/0048465 A1
(43) Pub. Date: Feb. 18, 2016

(54) WIRELESS AUTHENTICATION SYSTEM AND METHOD FOR UNIVERSAL SERIAL BUS STORAGE DEVICE

(71) Applicant: INNOSTOR TECHNOLOGY CORPORATION, HSINCHU COUNTY (TW)

(72) Inventor: CHIEN-MIN CHUANG, HSINCHU COUNTY (TW)

(21) Appl. No.: 14/718,347

(22) Filed: May 21, 2015

(30) Foreign Application Priority Data
Aug. 18, 2014 (TW) 103128278

(51) Int. Cl. G06F 12/14; H04W 12/06; H04L 29/06

(52) U.S. Cl. CPC G06F 12/1491; H04L 63/0876; H04L 63/0853; H04W 12/06

(57) ABSTRACT

A wireless authentication system for universal serial bus (USB) storage device has a USB storage device mounted on a computer unit with the storage device wirelessly connected to a remote device. The remote device has a dedicated application installed therein and transmitting authentication information to the storage device for establishing a dedicated link. A storage space of the storage device is set by the computer unit to be accessible. When users activate the remote device for sending out an operation command, the operation command includes at least one encryption command and at least one decryption command. The storage device performs a corresponding data management mode according to the operation command. Accordingly, the storage device can be wirelessly managed to enhance personal data security and operational convenience of the storage device.

### BACKGROUND OF THE INVENTION

1. Field of the Invention

The present invention relates to a universal serial bus (USB) storage device and, more particularly, to a wireless authentication system and a method for a USB storage device.

2. Description of the Related Art

The use of personal storage devices has become more and more commonplace lately. The importance of personal information security has also increased with the prevalence of the personal storage devices. Given a flash drive as an example, rising rate of important information is stored in the flash drive because of the portability of the flash drive. To ensure proper data security mechanism for the flash drive, password encryption could be the most direct approach. Only person who has the exclusive password is authorized to access or modify information stored in the flash drive. For example, a locked flash drive can be unlocked through particular software. Under the mechanism, as long as the user does not tell anybody else about the exclusive password, information stored in the flash drive can be safe to a certain degree. However, the particular software must be installed in a computer, such as a notebook computer or a desktop computer. If the particular software is not installed, it is unlikely to unlock the flash drive in a locked state, thus rendering the flash drive for use with security concern.

A conventional protected storage device can be directly unlocked without going through a computer to enable data write or read access to the storage device. The storage device includes a power supply module, a user's identification module and a control unit. The power supply module serves to provide an operating power and has a first power unit, a second power unit and a power controller. The first power unit serves to supply power. The power controller is coupled to the first power unit and the second power unit, and determines to charge the second power unit with the power from the first power unit and output the operating power. The power controller is connected to the user's identification module for the user's identification, such as biological information, fingerprint and the like, to receive user's identification information inputted by a user and generate comparison information according to the user's identification information. The control unit is connected to the user's identification module and decides to allow or deny user's access to the storage device according to the comparison information. When the storage device is positioned at a standby condition, the first power unit supplies the operating power to the user's identification module through the power controller, and simultaneously charges the second power unit. When the user's identification module is activated by the user's identification, the second power unit supplies an operating power required for encryption or decryption operation. The conventional storage device having the feature of user's identification can be used in a standalone fashion. For data encryption and decryption, instead of requiring connection to an external computer or external software application, the storage device can perform encryption and decryption operation on its own.

Although the conventional storage device employs the user's identification module to collect user′ biological information or fingerprint for users to perform data encryption and decryption on the storage device by themselves, the manufacturing cost of the storage device is relatively high. Additionally, the storage device is damage-prone due to frequent and repeated finger operation on the user's identification. When the storage device is faulty and is returned for repair service, personal information can be even more easily divulged.

### SUMMARY OF THE INVENTION

An objective of the present invention is to provide a wireless authentication system and a wireless authentication method for universal serial bus (USB) storage device requiring no additional software in a computer unit when users carry a USB storage device and intend to use the USB storage device on the computer unit, ensuring fast and convenient way of managing personal information in the USB storage device, and preventing the personal information from being damage-prone and easily divulged.

To achieve the foregoing objective, the wireless authentication system for USB storage device has a computer unit, a USB storage device and a remote device.

The USB storage device is mounted on the computer unit and has a first communication module, a power module, an access module and a controller.

The controller is electrically connected to the first communication module, the power module and the access module, receives a piece of authentication information through the first communication module, and determines if the access module is allowed for data access according to the piece of authentication information.

The remote device has a second communication module, wirelessly connects to the first communication module of the USB storage device through the second communication module, and transmits the piece of authentication information to the USB storage device.

Given the structure of the foregoing wireless authentication system, users can wirelessly manage the USB storage device through the remote device. When users establish a wireless link between the first communication module of the USB storage device and the second communication module of the remote device, the controller of the USB storage device receives the piece of authentication information from the first communication module, and sets information in the access module to be accessible according to the piece of authentication information. Accordingly, a fast, convenient, less damage-prone and low-cost means can be provided to enhance personal information security and operational convenience of the USB storage device.

To achieve the foregoing objective, the wireless authentication method for universal serial bus (USB) storage device is performed by a USB storage device when the USB storage device is wirelessly connected to a remote device, and the wireless authentication method has steps of:

accepting a piece of authentication information from the USB storage device to establish a dedicated wireless link between the USB storage device and the remote device having a dedicated application installed therein; and

changing a storage space of the USB storage device from a hidden state to an overt state for data access according to a successful and dedicated wireless link established between the USB storage device and the remote device.

The foregoing method is performed by the USB storage device wirelessly connected to the personal remote device having a dedicated application installed therein. When a wireless link is established between the USB storage device and the remote device, the storage device accepts the authentication information sent from users through the remote device, and the storage establishes a dedicated wireless link with the remote device according to the authentication information. The USB storage device changes the storage space thereof from a hidden state to an overt state for data access according to the success of establishing the dedicated link between the USB storage device and the remote device. As being fast and convenient, the wireless authentication method for USB storage device achieves personal data security and operational convenience of the USB storage device.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a wireless authentication system for a universal serial bus (USB) storage device in accordance with the present invention;

FIG. 2 is a functional block diagram of the system in FIG. 1;

FIG. 3 is a flow diagram of a wireless authentication method for a USB

storage device;

FIG. 4 is a flow diagram showing a fully-locking process of the method in FIG. 3;

FIG. 5 is a flow diagram showing a fully-unlocking process of the method in FIG. 3;

FIG. 6 is a flow diagram showing a partially-locking process of the method in FIG. 3; and

FIG. 7 is a flow diagram showing a partially-unlocking process of the method in FIG. 3.

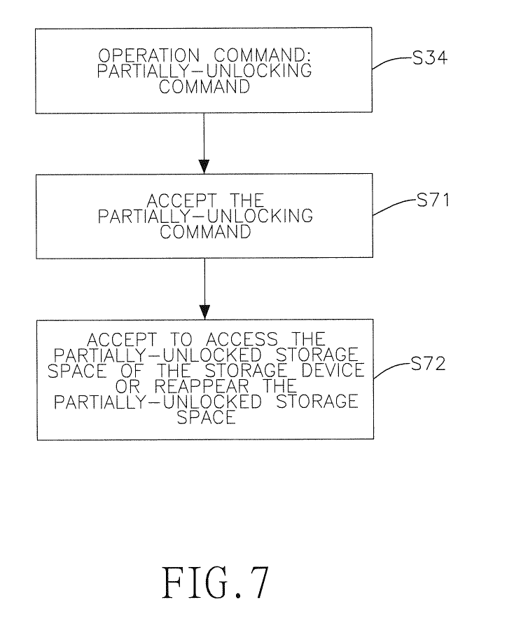

### DETAILED DESCRIPTION OF THE INVENTION

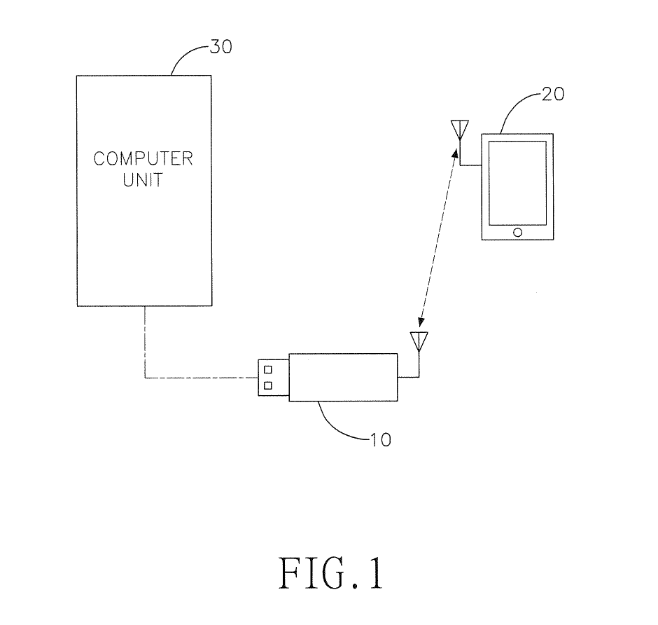

With reference to FIG. 1, a wireless authentication system for a universal serial bus (USB) storage device in accordance with the present invention has a USB storage device 10, a remote device 20 and a computer unit 30. The USB storage device 10 is mounted on the computer unit 30 for operation. The USB storage device 10 is wirelessly connected to the remote device 20. The computer unit 30 may be a notebook computer, a desktop computer, multimedia playing equipment, a tablet computer or the like.

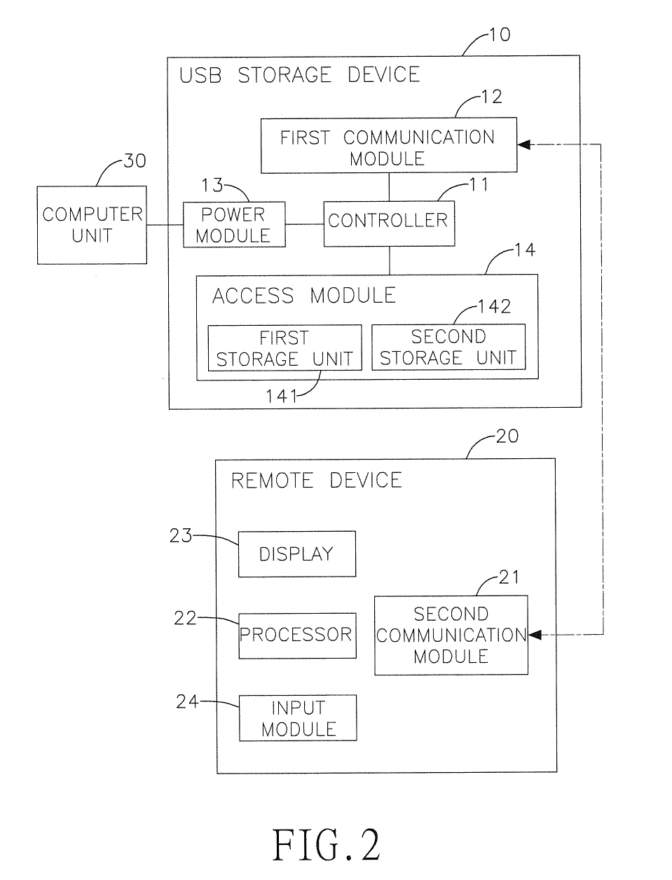

With reference to FIG. 2, the USB storage device 10 has a controller 11, a first communication module 12, a power module 13 and an access module 14. The controller 11 is electrically connected to the first communication module 12, the power module 13 and the access module 14. The power module 13 is electrically connected to the computer unit 30 to receive a power signal from the computer unit 30. In the present embodiment, the controller 11 receives apiece of authentication information transmitted from the remote device 20 through the first communication module 12 and determines if the access module 14 is allowed for data access according to the piece of authentication information. The access module 14 further has a first storage unit 141 and a second storage unit 142. The first storage unit 141 serves to store multiple pieces of confidential information. The second storage unit 142 serves to access multiple pieces of public information. The controller 11 determines if the first storage unit 141 or the second storage unit 142 is accessed according to the authentication information.

The remote device 20 has a second communication module 21 and an operation interface. The second communication module 21 is wirelessly connected to the first communication module 12 of the USB storage device 10. A communication protocol is used to establish a wireless link between the second communication module 21 and the first communication module 12 of the storage device 10 for the second communication module 21 to transmit the authentication information to the storage device 10. Users can use the operation interface to generate at least one operation command and transmit the at least one operation command to the USB storage device 10. The remote device 20 further has a processor 22, a display 23 and an input module 24. The processor 22 is electrically connected to the second communication module 21, the display 23 and the input module 24. When installed in the processor 22 of the remote device 20, an application dedicated to the remote device 20 is executed to establish a wireless link between the first communication module 12 and the second communication module 21 and to generate the operation interface. The display 23 and the input module 24 serve for users to view and operate the operation interface to transmit authentication information to the USB storage device for establishing a dedicated link. Users can send out the at least one operation command through the operation interface. The at least one operation command includes at least one encryption command, at least one decryption command or at least one other operation command. The storage device 10 performs a corresponding data management mode according to the at least one operation command to fully or partially lock or unlock the access module 14.

When the storage device 10 is mounted on the computer unit 30, a wireless link between the second communication module 21 of the remote device 20 and the first communication module 12 of the storage device 10 is established, such that the controller 11 of the USB storage device 10 sets the first storage unit 141 of the USB storage device 10 to be accessible (unlocked). To the computer unit 30, the first storage unit 141 is changed from a hidden state to an overt state. Thus, the computer unit 30 treats the first storage unit 141 as a safe disk region with an open and accessible storage space. When a wireless link between the first communication module 12 of the USB storage device 10 and the second communication module 21 of the remote device 20 fails to be established, the controller 11 changes the first storage unit 141 from the overt state to the hidden state. In other words, the first storage unit 141 of the USB storage device 10 is set to be inaccessible (locked). As for the computer unit 30, when the computer unit 30 fails to acquire an address of the safe disk region, the computer unit 30 treats the first storage unit 141 as a hidden disk region.

As can be seen from the foregoing wireless authentication system for a USB storage device, users can perform data management on the USB storage device 10 through a wireless communication means. When users input an operation command on the operation interface of the remote device 20, the remote device 20 transmits the operation command to the USB storage device 10 through the second communication module 21, and the controller 11 of the USB storage device 10 receives the operation command through the first communication module 12. The controller 11 decides if the first storage unit 141 or the second storage unit 142 of the access module 14 is accessible according to the operation command. Accordingly, given the fast, portable, less damage-prone and low-cost means, the USB storage device 10 enhances personal information security and operational convenience.

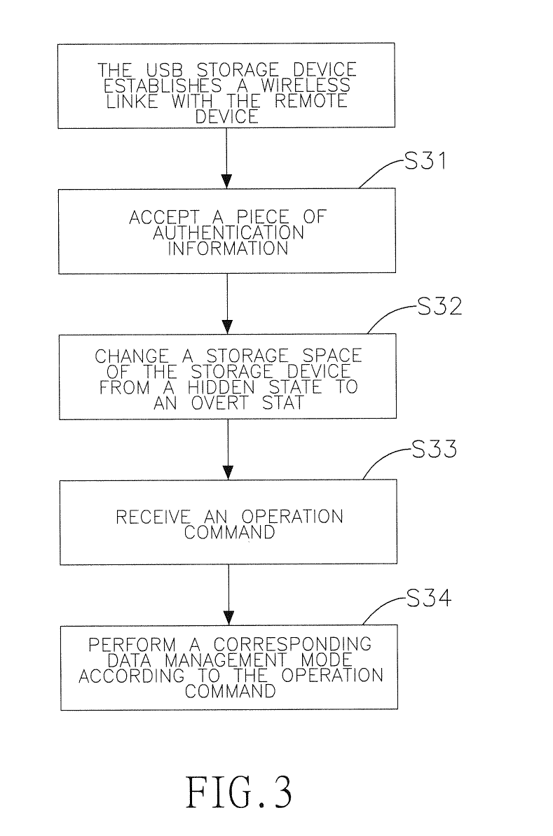

With reference to FIG. 3, a wireless authentication method for a USB storage device is performed by the USB storage device 10 when wirelessly connected to the remote device 20, and has the following steps.

Step S31: Accept a piece of authentication information from the storage device 10 to establish a dedicated wireless link between the storage device 10 and the remote device 20 having a dedicated application installed therein.

Step S32: Change a storage space of the storage device 10 from a hidden state to an overt state for data access according to a successful and dedicated wireless link established between the storage device 10 and the remote device 20 for the computer unit 30 to access.

Step S33: Receive an operation command generated from an operation interface provided by the dedicated application in the remote device 20.

Step S34: Perform a corresponding data management mode according to the operation command to set the storage device 10 to be hidden or overt.

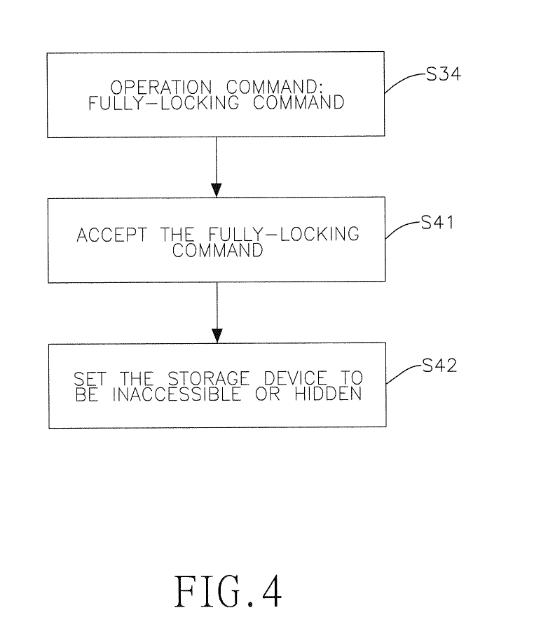

The remote device 20 belongs to a user. When the storage device 10 receives the piece of authentication information sent from the user through the remote device 20, the storage device 10 establishes the dedicated wireless link with the remote device 20 according to the received authentication information to perform a data management mode changing the storage space in the storage device 10 from a hidden state to an overt state. According to the data management mode of the storage device 10, the user can input a corresponding operation command through the operation interface of the remote device 20 and the remote device 20 transmits the operation command to the storage device 10 for the storage device 10 to perform the data management mode and configure itself to be overt or hidden. Furthermore, with reference to FIG. 4, when the storage device 10 receives the operation command and step S34 is performed according to the operation command, the step S34 further has the following steps when the operation command is a fully-locking command.

Step S41: Accept the fully-locking command.

Step S42: Set the storage device 10 to be inaccessible or hidden from the computer unit 30 according to the fully-locking command.

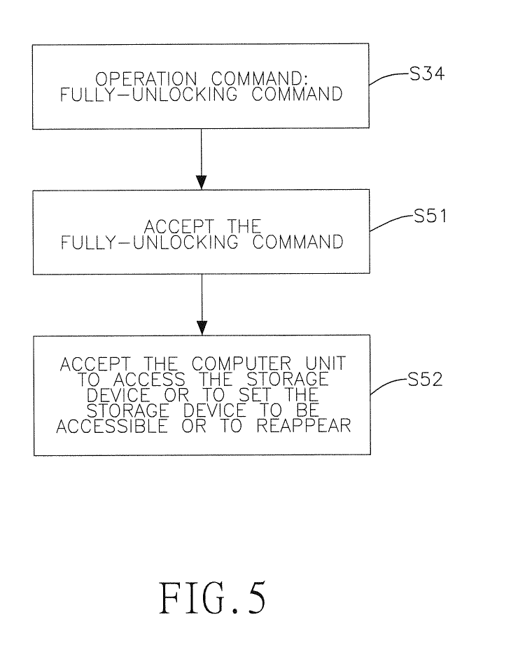

Further to step S34, with reference to FIG. 5, when users intend to perform a data management mode of the storage device 10 changing from a locked state to an unlocked state, the step S34 further has the following steps when the operation command is a fully-unlocking command.

Step S51: Accept the fully-unlocking command.

Step S52: Accept the computer unit 30 to access the storage device 10 or to set the storage device to be accessible or to reappear in the computer unit 30.

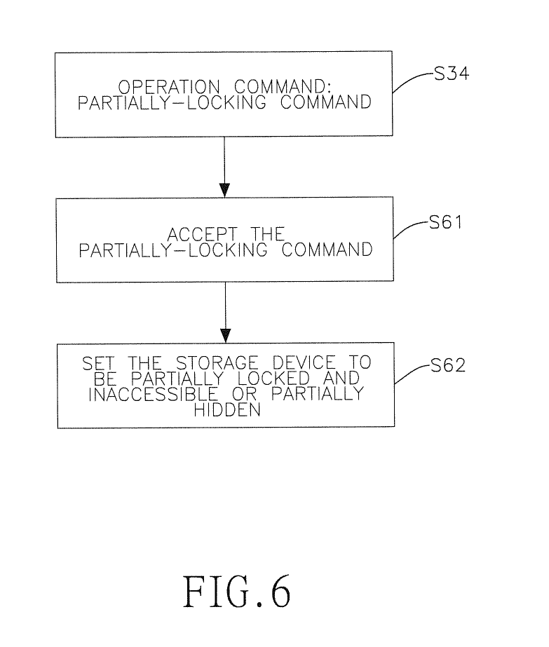

When users just intend to perform a data management mode associated with partial storage space of the storage device 10, the first storage unit 141 with multiple pieces of confidential information can be set to be encrypted and locked and the second storage unit 142 with multiple pieces of public information can be set to be accessible, or the first storage unit 141 and the second storage unit 142 can be set the other way around. With reference to FIG. 6, when the storage device 10 receives a partially-locking command, the step S34 further has the following steps.

Step S61: Accept the partially-locking command.

Step S62: Set the storage device 10 to be partially locked and inaccessible or partially hidden from the computer unit 30 according to the partially-locking command.

When users just intend to perform a data management mode unlocking the partially-locked storage space, with reference to FIG. 6, the operation command is a partially-unlocking command, and the step S34 further has the following steps.

Step S71: Accept the partially-unlocking command to unlock the partially-locked storage space of the storage device 10.

Step S72: Accept that the computer unit 30 accesses the partially-unlocked storage space of the storage device 10 or that the partially-unlocked storage space of the storage device 10 reappears in the computer unit 30 to be accessed.

The present application ensures fast and convenient wireless data management. When the storage device 10 receives the authentication information sent from the remote device 20, the storage device 10 establishes a dedicated wireless link with the remote device 20 according to the authentication information. A user further sends an operation command to the storage device 10 according to the user's request on a data management mode of the storage device 10 to instruct the storage device 10 to perform the data management mode. The authentication information includes a piece of management level information restricting users from accessing confidential information and privileges of using the access module 14. Given the management level information, the operation command received by the remote device 20 has more than one privilege. The privilege represented by each management level allows user to perform a corresponding data management mode. Accordingly, the present invention surely achieves the effect of enhancing personal information security and operational convenience.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A wireless authentication system for universal serial bus (USB) storage device, comprising:
a computer unit;
a USB storage device mounted on the computer unit and having:
a first communication module;
a power module;
an access module; and
a controller electrically connected to the first communication module, the power module and the access module, the controller receiving a piece of authentication information through the first communication module, and determining if the access module is allowed for data access according to the piece of authentication information; and
a remote device having a second communication module, wirelessly connecting to the first communication module of the USB storage device through the second communication module, and transmitting the piece of authentication information to the USB storage device.

2. The wireless authentication system as claimed in claim 1, wherein the access module has a first storage unit, when the first communication module successfully establishes a wireless link with the second communication module, the controller changes the first storage unit from a hidden state to an overt state for the computer unit to treat the first storage unit as an open and accessible disk region, and when the first communication module is not connected to the second communication module, the controller changes the first storage unit from the overt state to the hidden state for the computer unit to treat the first storage unit as a hidden and inaccessible disk region.

3. The wireless authentication system as claimed in claim 1, wherein a dedicated application installed in a processor of the remote device establishes the wireless link between the first communication module and the second communication module.

4. A wireless authentication method for universal serial bus (USB) storage device performed by a USB storage device when the USB storage device is wirelessly connected to a remote device, the wireless authentication method comprising steps of:
accepting a piece of authentication information from the USB storage device to establish a dedicated wireless link between the USB storage device and the remote device having a dedicated application installed therein; and
changing a storage space of the USB storage device from a hidden state to an overt state for data access according to a successful and dedicated wireless link established between the USB storage device and the remote device.

5. The wireless authentication method as claimed in claim 4, further comprising steps of:
receiving an operation command generated from the dedicated application installed in the remote device; and
performing a corresponding data management mode according to the operation command to set the storage device to be in the hidden state or in the overt state.

6. The wireless authentication method as claimed in claim 5, wherein when the operation command is a fully-locking command, the step of performing the corresponding data management mode has steps of:
accepting the fully-locking command; and
setting the storage device to be inaccessible or hidden according to the fully-locking command.

7. The wireless authentication method as claimed in claim 5, wherein when the operation command is a partially-locking command, the step of performing the corresponding data management mode has steps of:
accepting the partially-locking command; and
setting the storage device to be partially locked and inaccessible or partially hidden according to the partially-locking command.

8. The wireless authentication method as claimed in claim 6, wherein when the operation command is a fully-unlocking command, the step of performing the corresponding data management mode has steps of:
accepting the fully-unlocking command; and
setting the storage device to be accessible or reappearing according to the fully-unlocking command.

9. The wireless authentication method as claimed in claim 7, wherein when the operation command is a partially-unlocking command, the step of performing the corresponding data management mode has steps of:
accepting the partially-unlocking command to unlock a partially-locked storage space of the storage device; and
setting the partially-unlocked storage space of the storage device to be reappearing or accessible.

10. The wireless authentication method as claimed in claim 4, wherein the piece of authentication information includes a piece of management level information, and the operation command received by the remote device has more than one privilege.

11. The wireless authentication method as claimed in claim 5, wherein the piece of authentication information includes a piece of management level information, and the operation command received by the remote device has more than one privilege.

12. The wireless authentication method as claimed in claim 6, wherein the piece of authentication information includes a piece of management level information, and the operation command received by the remote device has more than one privilege.

13. The wireless authentication method as claimed in claim 7, wherein the piece of authentication information includes a piece of management level information, and the operation command received by the remote device has more than one privilege.

14. The wireless authentication method as claimed in claim 8, wherein the piece of authentication information includes a piece of management level information, and the operation command received by the remote device has more than one privilege.

15. The wireless authentication method as claimed in claim 9, wherein the piece of authentication information includes a piece of management level information, and the operation command received by the remote device has more than one privilege.
